(19) United States
(12) Patent Application Publication
(10) Pub. No.: US 2016/0342290 A1
(43) Pub. Date: Nov. 24, 2016

(54) METHOD FOR DISPLAYING APPLICATIONS AND ELECTRONIC DEVICE THEREOF

(71) Applicant: SAMSUNG ELECTRONICS CO., LTD., Suwon-si (KR)

(72) Inventors: Akhila MATHUR, Faridabad (IN); Anant JINDAL, Bapu nagar, Jaipur (IN); Ayushi GUPTA, Noida (IN); Dhananjay L. GOVEKAR, Maharashtra (IN); Munwar KHAN, Delhi (IN); Nitesh YADAV, New Delhi (IN); Prateek GUPTA, Ujjain (M.P.) (IN); Priyanka GOEL, Roorkee(Uttarakhand) (IN); Ritesh Kumar SINHA, Bihar (IN); Swati ASTHANA, Noida (IN)

(73) Assignee: SAMSUNG ELECTRONICS CO., LTD., Suwon-si (KR)

(21) Appl. No.: 15/158,774

(22) Filed: May 19, 2016

(30) Foreign Application Priority Data
May 19, 2015 (IN) 1413/DEL/2015
Jan. 12, 2016 (KR) 10-2016-0003773

(51) Int. Cl. G06F 3/0482; G06F 3/0488; G06F 3/0484

(52) U.S. Cl. CPC G06F 3/0482; G06F 3/04842; G06F 3/0488

(57) ABSTRACT

A method for managing applications in an electronic device is provided. The method includes displaying a user interface (UI) that has a first region and a second region in which a plurality of objects are displayed, displaying, in the first region, at least one object that corresponds to a designated input from among the plurality of objects, wherein each of the plurality of objects corresponds to one of an application stored in the device and a notification generated in the device, and wherein the at least one object usable for activating at least one function from among a plurality of functions associated with the application or the notification that corresponds to the selected object.

### CROSS-REFERENCE TO RELATED APPLICATIONS

The present application claims priority from an Indian Complete Patent Application filed on May 19, 2015 in the Indian Intellectual Property Office and assigned Serial No. 1413/DEL/2015(CS), and a Korean Patent Application filed on Jan. 12, 2016 in the Korean Intellectual Property Office and assigned Serial No. 10-2016-0003773, the disclosures of which are incorporated herein by reference in their respective entireties.

### BACKGROUND

1. Field

Exemplary embodiments generally relate to portable electronic devices and more particularly to portable electronic devices with touch surfaces that are configured to provide a User Interface (UI) for quick user access to multiple applications.

2. Description of the Related Art

Portable electronic devices such as smart phones, personal digital assistants (PDAs), and tablets have become popular and ubiquitous. The touch-sensitive surfaces in the portable electronic devices are typically used as an input means to facilitate interaction with the electronic device. Exemplary touch-sensitive surfaces include touch pads and touch screen displays. Such surfaces are widely used to select, launch, and manage applications in the electronic device.

Generally, the portable electronic devices have limited display screen areas and limited UI surface area, due to which managing and switching between the applications in the electronic devices are cumbersome and inefficient. For example, to perform even a basic action in a portable electronic device such as a smart phone, a user typically must open a full application. Thus, the user must continue switching between different applications in order to perform certain tasks. This situation creates a significant cognitive burden on the user.

For example, if the user is interested to initiate a call to a contact with whom the user has recently received an incoming call, the user must access the call application and then initiate the call. In another example, if the user is interested to send a message to the contact with whom the user has recently interacted, the user must access the message application and then send the message to the person. In addition, existing methods for switching and managing various applications to perform certain tasks take a relatively long time, thereby wasting energy and decreasing the overall user experience. This latter consideration is particularly important with respect to the portable electronic device, which is typically battery-operated.

Thus, there is a need for a robust and simple mechanism for dynamically switching and managing various applications to facilitate performance of certain tasks in the portable electronic devices with touch surfaces.

The above information is presented as background information in order to assist the reader to understand the present inventive concept. Applicants have made no determination and make no assertion as to whether any of the above might be applicable as prior art with regard to the present application.

### SUMMARY

A method for operating an electronic device according to an aspect of one or more exemplary embodiments comprises displaying a user interface (UI) that includes a first region and a second region within which a plurality of objects is displayed, and displaying, in the first region, at least one selected object that corresponds to a first input, from among the plurality of objects, wherein each of the plurality of objects corresponds to one from among an application stored in the device and a notification generated in the device, and wherein the at least one selected object is usable for activating at least one function from among a plurality of functions associated with the application or the notification that corresponds to the at least one selected object.

An electronic device according to another aspect of one or more exemplary embodiments comprises at least one processor and a display operatively coupled to the at least one processor, wherein the at least one processor is configured to display a user interface (UI) that includes a first region and a second region within which a plurality of objects is displayed, and to display, in the first region, at least one selected object that corresponds to a first input, from among the plurality of objects, wherein each of the plurality of objects corresponds to one from among an application stored in the device and a notification generated in the device, and wherein the at least one selected object is usable for activating at least one function from among a plurality of functions associated with the application or the notification that corresponds to the at least one selected object.

A computer program product according to another aspect of one or more exemplary embodiments comprises a non-transitory computer-readable medium having recorded thereon a program executable for performing a method that comprises displaying a user interface (UI) that includes a first region and a second region within which a plurality of objects is displayed, and displaying, in the first region, at least one selected object that corresponds to a first input, from among the plurality of objects, wherein each of the plurality of objects corresponds to one from among an application stored in the device and a notification generated in the device, and wherein the at least one selected object is usable for activating at least one function from among a plurality of functions associated with the application or the notification that corresponds to the at least one selected object.

These and other aspects of the exemplary embodiments disclosed herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the exemplary embodiments without departing from the spirit thereof, and the exemplary embodiments include all such modifications.

### BRIEF DESCRIPTION OF THE DRAWINGS

Exemplary embodiments are illustrated in the accompanying drawings, throughout which like reference letters indicate corresponding parts in the various figures. The exemplary embodiments will be better understood from the following description with reference to the drawings, in which:

FIG. 1 illustrates an electronic device for dynamically switching and managing applications by dividing a screen of the electronic device into a first portion and a second portion, according to one or more exemplary embodiments;

FIG. 2 illustrates various units of the electronic device for dynamically switching and managing applications, according to one or more exemplary embodiments;

FIG. 3 illustrates various units of a controller unit in the electronic device, according to one or more exemplary embodiments;

FIG. 4 is a flow diagram illustrating a method for dynamically switching and managing applications in the electronic device, according to one or more exemplary embodiments;

FIG. 5 is another flow diagram illustrating a method for dynamically switching and managing applications in the electronic device, according to one or more exemplary embodiments;

FIG. 6 is another flow diagram illustrating a method for dynamically switching and managing applications in the electronic device, according to one or more exemplary embodiments;

FIG. 7 illustrates an example system for displaying a message application and a call application on the first portion of the screen of the electronic device, according to one or more exemplary embodiments;

FIGS. 8A, 8B, and 8C illustrate an example for launching an outgoing call activity corresponding to the call application on the first portion of the screen of the electronic device, according to one or more exemplary embodiments;

FIGS. 9A, 9B, 9C, and 9D illustrate an example for dynamically switching a music application displayed on the first portion to an activity list in the second portion of the screen of the electronic device when an incoming call activity is displayed on the first portion, according to one or more exemplary embodiments;

FIGS. 10A, 10B, and 10C illustrate another example for dynamically switching a camera application displayed on the first portion to the activity list in the second portion when a note pad application is displayed on the first portion, according to one or more exemplary embodiments;

FIG. 11 illustrates an example for deleting the application from the activity list displayed on the second portion of the screen of the electronic device, according to one or more exemplary embodiments;

FIG. 12 illustrates an example to schedule the outgoing call activity corresponding to the call application from the activity list displayed on the second portion of the screen of the electronic device, according to one or more exemplary embodiments;

FIG. 13A and FIG. 13B illustrate an example for controlling a smart Television (TV) by launching a smart TV application on the first portion of the screen, according to one or more exemplary embodiments;

FIG. 14A and FIG. 14B illustrate an example for controlling an air conditioner (AC) by launching an AC application on the first portion of the screen, according to one or more exemplary embodiments;

FIG. 15 illustrates another example for managing a smart classroom application in the electronic device, according to one or more exemplary embodiments;

FIG. 16 illustrates an example for dynamically synchronizing the first portion of the screen of the electronic device with a watch, according to one or more exemplary embodiments;

FIG. 17 illustrates notifications displayed on the first portion of the screen of the electronic device, according to one or more exemplary embodiments;

FIGS. 18A, 18B, and 18C illustrate an example for launching a mini notepad application on the first portion and a full notepad application on the screen of the electronic device, according to one or more exemplary embodiments; and

FIG. 19 illustrates a computing environment implementing the method for dynamically switching and managing applications of the electronic device, according to one or more exemplary embodiments.

### DETAILED DESCRIPTION

Exemplary embodiments and the various features and advantageous details thereof are explained more fully with reference to the non-limiting exemplary embodiments that are illustrated in the accompanying drawings and detailed in the following description. Descriptions of well-known components and processing techniques are omitted so as to not unnecessarily obscure the exemplary embodiments. Further, the various exemplary embodiments described herein are not necessarily mutually exclusive, as some exemplary embodiments can be combined with one or more other exemplary embodiments to form new exemplary embodiments. The term “or” as used herein, refers to a non-exclusive or, unless otherwise indicated. The examples used herein are intended merely to facilitate understanding of ways in which the exemplary embodiments can be practiced and to further enable those skilled in the art to practice the exemplary embodiments. Accordingly, the examples should not be construed as limiting the scope of the exemplary embodiments described herein.

The exemplary embodiments disclose a method and system for dynamically switching and managing various applications to facilitate the performance of certain tasks in portable electronic devices with touch surfaces. The method includes displaying a first application on a first portion of a screen of the electronic device and an activity list on a second portion of the screen of the electronic device. The first application can be a miniaturized application that includes basic actionable user controls of a full application. In an exemplary embodiment, the activity list includes at least one of a recently used application, favorite applications, and notifications.

Further, the method includes receiving an input to launch an activity. In an exemplary embodiment, the activity is selected from the activity list, where the input is received from the user in order to select the activity from the activity list to launch the activity. In another exemplary embodiment, the activity is an incoming notification. Further, the method includes displaying a second application that corresponds to the activity on the first portion of the screen of the electronic device. The first application is dynamically switched to the activity list displayed on the second portion when the second application is displayed on the first portion of the screen. In an exemplary embodiment, the second application can be a miniaturized application having basic actionable user controls of a full application.

Further, the method includes re-launching the first application on the first portion of the screen when the activity associated with the second application is completed. In an exemplary embodiment, the second application is dynamically switched to the activity list when the first application is displayed on the first portion of the screen.

In an exemplary embodiment, the first portion of the screen of the electronic device can be dynamically synchronized with one or more wearable devices. Further, the first portion is dynamically synchronized with the wearable devices in order to shift current ongoing activities or upcoming activities or priority tasks onto a display portion of the wearable device. For example, the first portion of the screen of the electronic device can be synchronized with a smart watch.

In an exemplary embodiment, the user can drag and drop the activity that corresponds to the application from the activity list on the second portion to the first portion of the screen.

In an exemplary embodiment, by default, the priority activities or the favorite activities appear at the top of the activity list. In an exemplary embodiment, the user may provide ratings to the applications in the activity list. Further, the activity list can be sorted based on the ratings provided by the user. In an exemplary embodiment, similar applications in the activity list can be grouped or bundled together based on a context, similarity, emergency applications, or the like. Further, the screen may be modified to show a micro-level listing of the applications which form a part of the bundles.

Further, the screen can include a toggle button, where the selected running application can be switched as per the user requirement from full application mode to the miniaturized application mode and vice versa. In the conventional systems and methods, the portable electronic devices have limited display screens and constraints that relate to the UI surface area, due to which managing and switching between the applications in the electronic devices is cumbersome and inefficient. For example, to perform even a basic action in a portable electronic device such as a smart phone, a user always has to open a full application. Thus, the user needs to continually switch between different applications to perform certain tasks. This situation creates a significant cognitive burden on the user.

Unlike conventional systems and methods, in an exemplary embodiment, the user can access different applications on the screen of the electronic device from which the user can view and perform actions from the same screen. Further, the users need not switch between different applications to perform certain tasks. Due to dynamic switching between the applications, the number of interactions to perform certain tasks can be considerably reduced, thereby improving the overall user experience. Further, the proposed system and method according to one or more exemplary embodiments can save processor power and improve speed for accessing application features.

In an example, consider a scenario in which the first portion of the screen is displaying the music application which is a currently ongoing activity. The second portion of the screen includes the activity (i.e., activity imprint) that corresponds to the message application, the call application, and the camera application. When the user receives any priority notification, the notification will be displayed on the first portion of the screen for a period of time. Further, the music application, which is a currently ongoing activity, is dynamically switched to the activity list displayed on the second portion of the screen when the notification is displayed on the first portion of the screen. The notification is displayed on the first portion for the time period and is then dynamically switched to the activity list on the second portion. The music application is re-launched on the first portion.

Throughout the description the terms “SCREEN” and “DISPLAY SCREEN” are used interchangeably.

Further, the labels such as “first”, “second,” are used merely to differentiate the portions of the screen of the electronic device and do not limit the scope of the exemplary embodiments.

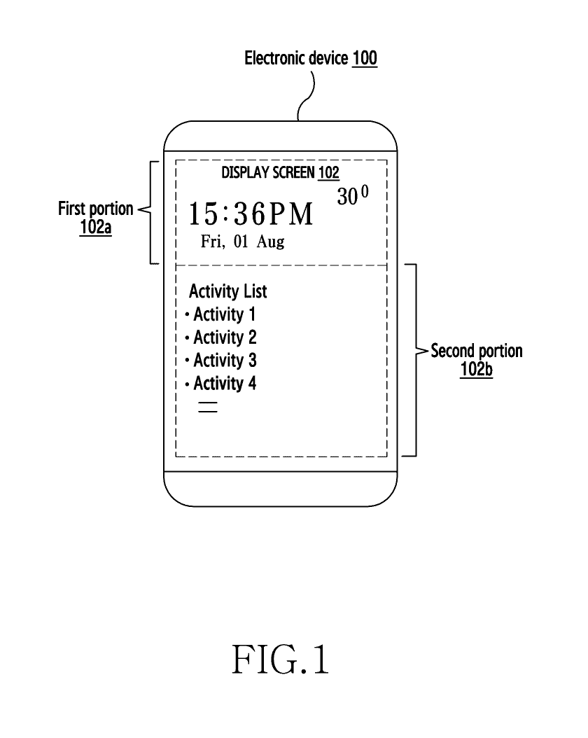

Referring now to the drawings, and more particularly to FIGS. 1 through 19, where similar reference characters denote corresponding features consistently throughout the figures, there are shown exemplary embodiments.

FIG. 1 illustrates an electronic device 100 for dynamically switching and managing applications in the electronic device 100, according to one or more exemplary embodiments as disclosed herein. The electronic device 100 can be, for example and not limited to any of a laptop, a desktop computer, a mobile phone, a smart phone, a Personal Digital Assistant (PDA), a tablet, a phablet, a consumer electronic device, a server, or any other electronic device.

In an exemplary embodiment, the electronic device 100 includes a screen 102. The screen 102 can be, for example but not limited to, divided into a first portion 102a and a second portion 102b. In an example, the first portion 102a includes a header Graphical User Interface (GUI).

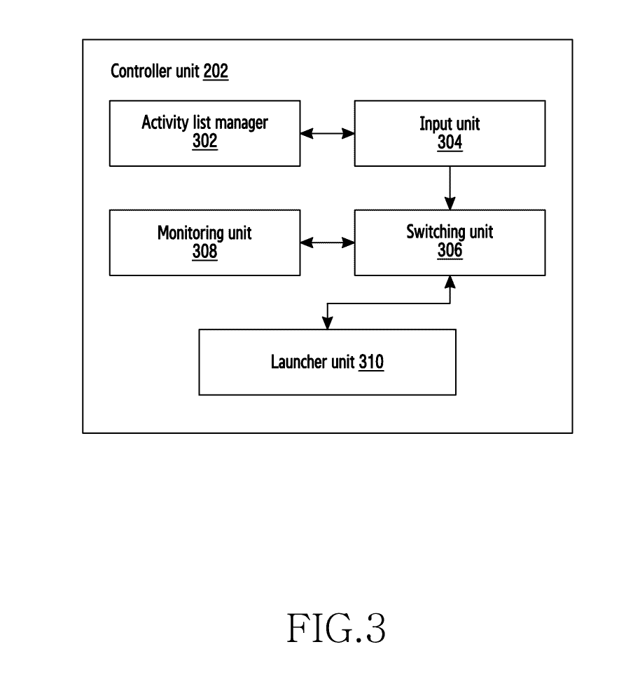

Initially, the first portion 102a of the screen 102 can be configured to display default information, such as time and weather, in an idle condition as shown in FIG. 1. While the FIG. 1 illustrates an exemplary embodiment in which default information is displayed, the first portion 102a according to various exemplary embodiments is configured to display information that corresponds to an application which was recently executed or a notification that was recently generated in the electronic device 100. The second portion 102b of the screen 102 can be configured to display an activity list. In an exemplary embodiment, the activity list includes at least one of a recently used application, favorite applications, and notifications. For example, all the attended or un-attended notifications received by the user and the user's activity are displayed on the screen of the electronic device 100 such that the user can take action on the activity. The applications can include, for example but not limited to, any of a message application, a call application, a music application, a calendar application, a Notepad application, a calculator application, a wireless fidelity (Wi-Fi) application, a Bluetooth application, a reminder application, a camera application, a memo application, and/or any other applications. In an example, the activity list may be used to switch between actions within multiple miniaturized applications rendered in an advance header application launcher (i.e., launcher unit). The functionalities of the launcher unit are described below in conjunction with FIG. 3.

The activity list is displayed via a plurality of objects in the second portion 102b. Each of the plurality of objects corresponds to an application stored in the electronic device 100 or a notification generated in the electronic device 100. Each of the plurality of objects can be generated when a corresponding application is executed or a corresponding notification is generated.

The plurality of objects are displayed by aligning the objects based on a predetermined ordering rule. For example, the plurality of objects are displayed by aligning based on an order of execution of the corresponding application or an order of generation of the corresponding notification. For another example, the plurality of objects are displayed by aligning based on a predetermined priority.

In an exemplary embodiment, the user executes an application that corresponds to an object which has been selected from among the plurality of objects. The executed application is executed in a full application state which activates all the functions of the application. Alternatively, the executed application may be executed in a miniaturized application state which activates a subset of all the functions (for example, a representative subset) of the application.

In an exemplary embodiment, the notifications are displayed for a period of time on the first portion 102a of the screen 102, and then dynamically switched to the second portion 102b after the time period. The notifications can be related to any of a battery low condition, a missed call, a new message, earphones connected or disconnected, downloading file status, a Wi-Fi, Bluetooth, brightness control, and/or the like. In an example, the time period can be pre-defined by the user. In another example, the time period can be dynamically determined based on a type of the notification. Further, the notifications appear in the activity list and are actionable. Acting on the notification leads to a displaying of the notification details, either in the inline view or the full detail application of the respective notification.

In an exemplary embodiment, the electronic device 100 can be configured to display a first application on the first portion 102a of the screen 102 and to display the activity list on the second portion 102b of the screen 102. In an exemplary embodiment, the first application is a miniaturized application that includes basic actionable user controls of a full application. For example, the miniaturized application may refer to application that includes at least one function from among the plurality of functions of the full application.

In an exemplary embodiment, the miniaturized application can be developed as another application, based on the full application. For example, if the full application is an application installed in the electronic device 100, the miniaturize application can be developed by the developer of the full application. In this case, the user can use the miniaturized application by implementing an update of the full application or by installation of the miniaturized application. If the full application is a default application, the miniaturized application can be developed by the developer of the electronic device 100 or the network provider. In this case, since the miniaturized application is installed in the electronic device 100, the user can use the miniaturized application without an independent installation or an independent update.

In another exemplary embodiment, the miniaturized application can be used via a development of a user interface for the miniaturized application, without a development of an independent application. The user interface for the miniaturized application comprises at least one object which is usable for activating at least one function from among a plurality of functions of the full application. For example, when the user wants to execute the miniaturized version of a call application, the electronic device 100 can display the user interface for the miniaturized application in the first portion 102a in response to a user's input. The user interface for the miniaturized application can comprise at least one object. The at least one object is usable for activating a function for placing an outgoing call or a function for transmitting a short message service (SMS) message. The user can use the function for placing an outgoing call or the function for transmitting the SMS message via a touch input that relates to the at least one object, without a transition of the view.

Further, the electronic device 100 can be configured to receive an input to launch an activity. In an exemplary embodiment, the activity is selected from the activity list, where the input is received from the user in order to select the activity from the activity list to launch the activity. In another exemplary embodiment, the activity is an incoming notification. In an exemplary embodiment, the activity can be related to any of sending a message, initiating an outgoing call, capturing photos, scheduling a birthday reminder, and/or the like. For example, by selecting the activity in the activity list displayed on the second portion of the screen, a small application window is launched on a top header part (i.e., first portion 102a) of a launcher (i.e., screen) in which the user can perform corresponding actions.

Further, the electronic device 100 can be configured to display a second application that corresponds to the activity on the first portion 102a of the screen 102. In an exemplary embodiment, the first application is dynamically switched to the activity list displayed on the second portion 102b of the screen when the second application is displayed on the first portion 102a of the screen 102. In an exemplary embodiment, the second application is a miniaturized application that includes basic actionable user controls of a full application. For example, when the second application is displayed on the header, the user can view the displayed application and can scroll through the activity list displayed on the second portion of the launcher.

Further, the electronic device 100 can be configured to re-launch the first application on the first portion 102a when the activity associated with the second application is completed. The second application is dynamically switched to the activity list when the first application is displayed on the first portion 102a of the screen 102. Unlike conventional systems, the user can simultaneously view the application on the first portion 102a of the screen 102 and the activity list on the second portion 102b of the screen 102 of the electronic device 100.

The electronic device can display the first application, the second application, and the activity list by using any of various methods.

Alternatively with respect to the above examples, the activity list and the first application can be displayed by overlapping. In this case, one of the activity list and the first application can be displayed by a format of a pop-up window.

For another example, the activity list and the second application can be displayed by overlapping. In this case, one of the activity list and the second application can be displayed by a format of a pop-up window.

For another example, the activity list can be displayed in a main display of the electronic device, and the first application or the second application can be displayed in a secondary display (for example, an edge display) of the electronic device.

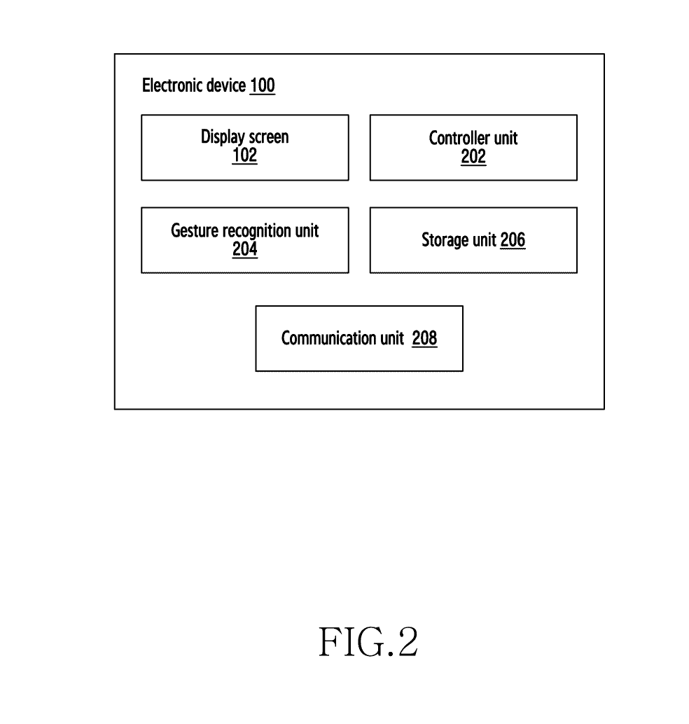

In an exemplary embodiment, the first portion 102a of the screen 102 of the electronic device 100 can be dynamically synchronized with at least one wearable device. Further, the first portion 102a of the screen 102 can be dynamically synchronized with the at least one wearable device so as to shift current ongoing activities or upcoming activities or priority tasks onto a display portion of the at least one wearable device. The activity that correspond to the application can be given a relatively high priority on the basis of time, location, a prior user pattern, or the like. Further, the functionalities of the electronic device 100 can be described in conjunction with FIG. 2. Unlike conventional systems, the header GUI is provided for enabling dynamic switching of the applications while viewing from the activity list displayed on the second portion 102b of the screen 102.

In an exemplary embodiment, the electronic device 100 can synchronize with the at least one wearable device via a proximity communication. For example, the electronic device 100 can synchronize with the at least one wearable device via the Bluetooth scheme. The electronic device can synchronize with the at least one wearable device by transmitting information for displaying contents that are displayed on the first portion 102a and the second portion 102b in the screen 102 in the at least one wearable device.

FIG. 1 shows a limited overview of the electronic device 100; however, it is to be understood that another exemplary embodiment is not limited thereto. Further, the electronic device 100 can include any of various component elements which are configured to communicate among each other, together with other hardware or software components. For example, the component can include, but not limited to, any of a process running in the electronic device, an executable process, a thread of execution, a program, a microprocessor, and/or a computer. By way of illustration, both an application running on an electronic device 100 and the electronic device can be the component.

FIG. 2 illustrates various units of the electronic device 100 for dynamically switching and managing applications, according to one or more exemplary embodiments. In an exemplary embodiment, the electronic device 100 includes the display screen 102, a controller unit (also referred to herein as a “controller”) 202, a gesture recognition unit (also referred to herein as a “gesture recognizer”) 204, a storage unit (also referred to herein as a “storage”) 206, and a communication unit (also referred to herein as a “communicator”) 208. The functionalities of the display screen 102 are described above in conjunction with FIG. 1.

Further, the controller unit 202 can be configured to display the first application on the first portion 102a of the display screen 102 and to display the activity list on the second portion 102b of the display screen 102. In an exemplary embodiment, the first application can include the miniaturized application that has basic actionable user controls of the full application. In an exemplary embodiment, the activity list includes at least one of a recently used application, favorite applications, and notifications. For example, all read and unread activities are maintained in the activity list on the second portion 102b of the screen 102. When the user selects the activity that corresponds to the application, the miniaturized application is launched on the header of the launcher in which the user can perform corresponding actions.

In an exemplary embodiment, the notifications are displayed for the time period on the first portion 102a of the screen 102, and then dynamically switched to the second portion 102b after the time period. In an example, the time period can be pre-defined by the user. In another example, the time period can be dynamically determined based on the type of the notification.

Further, the gesture recognition unit 204 can be configured to recognize the input in order to launch the activity. In an exemplary embodiment, the activity is selected from the activity list, where the input is received from the user in order to select the activity from the activity list to launch the activity. In another exemplary embodiment, the activity is an incoming notification. Further, the gesture recognition unit 204 can be configured to send the recognized input to the controller unit 202. After receiving the input to launch the activity, the controller unit 202 can be configured to display the second application that corresponds to the activity on the first portion 102a of the screen 102. The first application is dynamically switched to the activity list which is displayed on the second portion 102b when the second application is displayed on the first portion 102a of the screen 102. In an exemplary embodiment, the second application can be the miniaturized application that has basic actionable user controls of the full application.

Further, the controller unit 202 can be configured to re-launch the first application on the first portion 102a when the activity associated with the second application is completed. In an exemplary embodiment, the second application is dynamically switched to the activity list when the first application is displayed on the first portion 102a of the screen 102.

In an exemplary embodiment, the controller unit 202 can be configured to dynamically synchronize the first portion 102a of the screen 102 with the at least one wearable device. Further, the first portion 102a can be dynamically synchronized with the at least one wearable device in order to shift current ongoing activities or upcoming activities or priority tasks onto the display portion of the at least one wearable device. Further, the functionalities of the controller unit 202 are described below in conjunction with FIG. 3.

Further, the storage unit 206 can encompass one or more memory devices of any of a variety of forms (e.g., read-only memory, random access memory, static random access memory, dynamic random access memory, or the like) and can be used by the controller unit 202 to store and retrieve data. The data that is stored by the storage unit 206 can include operating systems, applications, and/or informational data. Each operating system includes executable code that controls basic functions of the electronic device 100, such as interaction among the various internal components, communication with external devices via the wireless transceivers or the component interface, and/or storage and retrieval of applications and data to and from the storage unit 206.

Further, the communication unit 208 can be configured to receive a notification that corresponds to the application. Further, the communication unit 208 can be configured to send the current ongoing activities or upcoming activities or priority tasks to be displayed on the display portion of the at least one wearable device.

FIG. 2 shows a limited overview of the electronic device 100; however, it is to be understood that another exemplary embodiment is not limited thereto. Further, the electronic device 100 can include any of various types of units which are configured to communicate among each other together with other hardware or software components. For example, the component can include, but not limited to, any of a process running in the electronic device 100, an executable process, a thread of execution, a program, a microprocessor, and/or a computer. By way of illustration, both an application running on an electronic device 100 and the electronic device 100 can be the component.

FIG. 3 shows various units of the controller unit 202 in the electronic device 100, according to one or more exemplary embodiments. In an exemplary embodiment, the controller unit 202 includes an activity list manager 302, an input unit 304, a switching unit (also referred to herein as a “switcher” or a “switch”) 306, a monitoring unit (also referred to herein as a “monitor”) 308, and a launcher unit (also referred to herein as a “launcher”) 310.

The activity list manager unit 302 can be configured to include the activity list that is displayed on the second portion 102b of the screen 102. The activity list includes at least one of a recently used application, favorite applications, and notifications. Further, the input unit 304 can be configured to receive the input to launch the activity. In an exemplary embodiment, the activity is selected from the activity list, where the input is received from the user in order to select the activity from the activity list to launch the activity. In another exemplary embodiment, the activity is the incoming notification. In an exemplary embodiment, the input can be the gesture performed by the user that relates to a selection of the activity from the activity list on the second portion 102b. Further, the input unit 304 can be configured to send the input to the switching unit 306. After receiving the input from the input unit 304, the switching unit 306 can be configured to dynamically switch the first application, which is currently displayed on the first portion 102a, to the activity list on the second portion 102b. Further, the switching unit 306 can be configured to send the second application that corresponds to the activity to be launched on the first portion 102a of the screen 102 to the launcher unit 310. After receiving a request to launch the second application that corresponds to the activity, the launcher unit 310 can be configured to display the second application that corresponds to the activity on the first portion 102a of the screen 102 of the electronic device 100.

Further, the monitoring unit 308 can be configured to monitor whether the activity associated with the second application has been completed. If the activity associated with the second application is completed, then the switching unit 306 can be configured to dynamically switch the second application to the activity list when the first application is displayed on the first portion 102a of the screen 102. Further, the launcher unit 310 can be configured to automatically free the memory of the launched second application once the activity that corresponds to the second application has been completed.

FIG. 3 shows a limited overview of the controller unit 202; however, it is to be understood that another exemplary embodiment is not limited thereto. Further, the controller unit 202 can include any of various types of units which are configured to communicate among each other together with other hardware or software components.

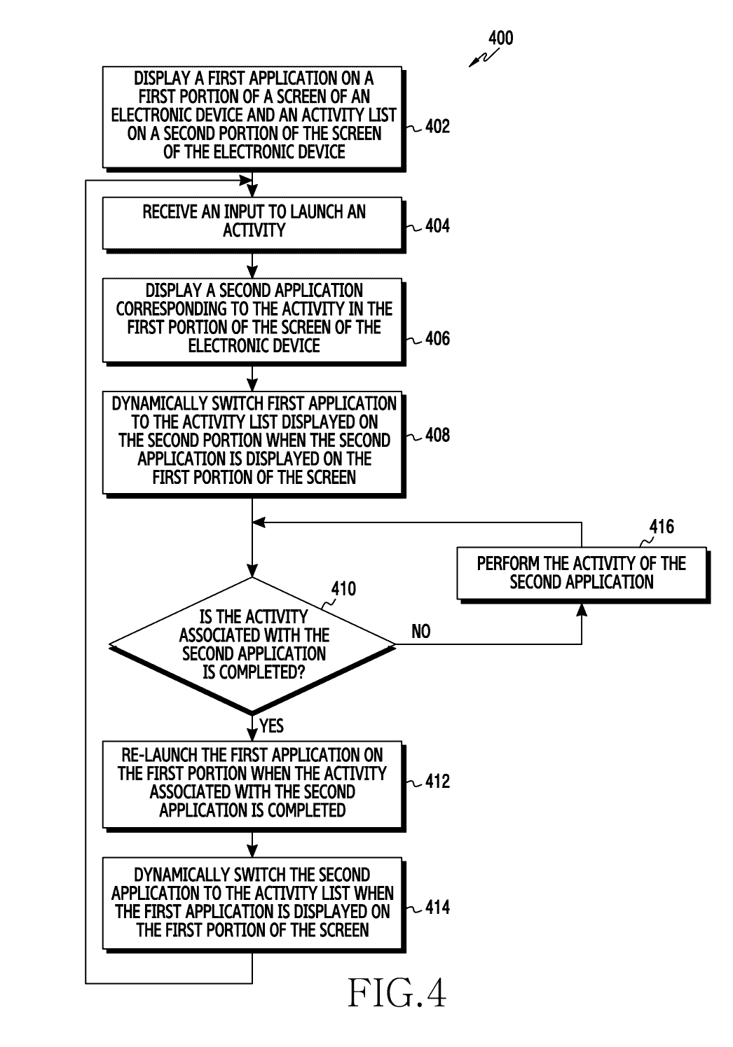

FIG. 4 is a flow diagram illustrating a method 400 for dynamically switching and managing applications in the electronic device 100, according to one or more exemplary embodiments. In operation 402, the method 400 includes displaying the first application on the first portion 102a of the screen 102 of the electronic device 100 and the activity list on the second portion 102b of the screen 102 of the electronic device 100. The method 400 entails enabling the controller unit 202 to display the first application on the first portion 102a of the screen 102 and the activity list on the second portion 102b of the screen 102. In an exemplary embodiment, the first application can be the miniaturized application that has basic actionable user controls of the full application.

In an exemplary embodiment, the activity list includes at least one of a recently used application, favorite applications, and notifications. The applications can include, for example but not limited to, any of the message application, the call application, the music application, the calendar application, the Notepad application, the calculator application, the Wi-Fi application, the Bluetooth application, the reminder application, the camera application, the memo application, and/or any other applications.

In an exemplary embodiment, the notifications are displayed for the time period on the first portion 102a of the screen 102, and then dynamically switched to the second portion 102b after the time period. The notifications can be related to any of the battery low condition, the missed call, the new message, earphones connected or disconnected, downloading file status, the Wi-Fi, the Bluetooth, brightness control, or the like. In an example, the time period can be pre-defined by the user. In another example, the time period can be dynamically determined based on the type of the notification.

In operation 404, the method 400 includes receiving the input to launch the activity. In an exemplary embodiment, the activity is selected from the activity list, where the input is received from the user in order to select the activity from the activity list to launch the activity. In another exemplary embodiment, the activity is the incoming notification. In an exemplary embodiment, the activity can be related to any of sending the message, initiating the outgoing call, capturing photos, scheduling the birthday reminder, or the like. The method 400 entails enabling the controller unit 202 to receive the input to launch the activity.

In operation 406, the method 400 includes displaying the second application that corresponds to the selected activity on the first portion 102a of the screen 102 of the electronic device 100. The method 400 entails enabling the controller unit 202 to display the second application that corresponds to the activity on the first portion 102a of the screen 102. In an exemplary embodiment, the second application can be a miniaturized application that has basic actionable user controls of a full application.

In operation 408, the method 400 includes dynamically switching the first application to the activity list displayed on the second portion 102b when the second application is displayed on the first portion 102a of the screen 102. The method 400 entails enabling the controller unit 202 to dynamically switch the first application to the activity list displayed on the second portion 102b when the second application is displayed on the first portion 102a of the screen 102.

If it is determined, in operation 410, that the activity associated with the second application has been completed, then, in operation 412, the method 400 includes re-launching the first application on the first portion 102a of the screen 102. The method 400 entails enabling the controller unit 202 to re-launch the first application on the first portion 102a of the screen 102. In operation 414, the method 400 includes dynamically switching the second application to the activity list when the first application is displayed on the first portion 102a of the screen 102, and returning to operation 404. The method 400 entails enabling the controller unit 202 to dynamically switch the second application to the activity list when the first application is displayed on the first portion 102a of the screen 102. If it is determined, in operation 410, that the activity associated with the second application has not been completed, then, in operation 416, the method 400 includes performing the activity of the second application, and returning to operation 410.

Unlike conventional systems, the user can access all activities that respectively correspond to multiple applications displayed on the second portion 102b of the screen 102 of the electronic device 100, thereby empowering the user to take actions from the same screen 102.

The various actions, acts, blocks, steps, or the like in the method 400 may be performed in the order presented, in a different order, or simultaneously. Further, in some exemplary embodiments, some of the actions, acts, blocks, steps, or the like may be omitted, added, modified, skipped, or the like without departing from the scope of the present inventive concept.

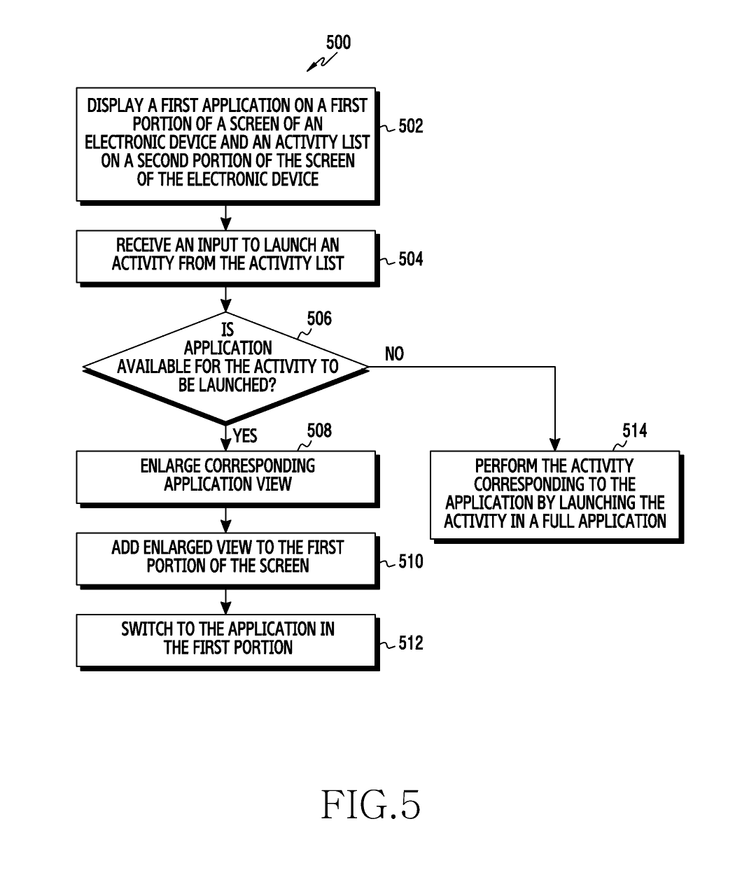

FIG. 5 is another flow diagram illustrating a method 500 for dynamically switching and managing applications in the electronic device 100, according to one or more exemplary embodiments. In operation 502, the method 500 includes displaying the first application on the first portion 102a of the screen 102 and the activity list on the second portion 102b of the screen 102. The method 500 entails enabling the controller unit 202 to display the first application on the first portion 102a of the screen 102 and the activity list on the second portion 102b of the screen 102. In an exemplary embodiment, the first application can be the miniaturized application that includes basic actionable user controls of the full application.

In an exemplary embodiment, the activity list includes at least one of a recently used application, favorite applications, and notifications. The applications can include, for example but not limited to, any of the message application, the call application, the music application, the calendar application, the Notepad application, the calculator application, the Wi-Fi application, the Bluetooth application, the reminder application, the camera application, the memo application, and/or any other applications.

In an exemplary embodiment, the notifications are displayed for the time period on the first portion 102a of the screen 102, and then dynamically switched to the second portion 102b after the time period. In an example, the time period can be pre-defined by the user. In another example, the time period can be dynamically determined based on the type of the notification.

In operation 504, the method 500 includes receiving the input to launch the activity from the activity list. In an exemplary embodiment, the activity is selected from the activity list, where the input is received from the user in order to indicate the activity from the activity list to launch the activity. In another exemplary embodiment, the activity is the incoming notification. The method 500 entails enabling the controller unit 202 to receive the input to launch the activity from the activity list. In an exemplary embodiment, the activity can be related to any of sending the message, initiating the outgoing call, capturing photos, scheduling the birthday reminder, or the like. If it is determined, in operation 506, that the application (i.e., application window) for the activity to be launched is available, then, in operation 508, the method 500 includes enlarging (i.e., inflating) the corresponding application view for the activity to be launched. The method 500 entails enabling the controller unit 202 to enlarge the corresponding application view for the activity to be launched. In an exemplary embodiment, the enlarging of the corresponding application view may include retrieving the miniaturized application that corresponds to the selected activity, from a storage location, and rendering the miniaturized application in the first portion 102a of the screen 102.

In operation 510, the method 500 includes adding the enlarged (i.e., inflated) view to the first portion 102a of the screen 102. The method 500 entails enabling the controller unit 202 to add the enlarged view to the first portion 102a of the screen 102. In operation 512, the method 500 includes switching to the application that is displayed on the first portion 102a of the screen 102. The method 500 entails enabling the controller unit 202 to switch to the application on the first portion 102a of the screen 102.

If it is determined, in operation 506, that the application for the activity to be launched is unavailable, then, in operation 514, the method 500 includes performing the activity that corresponds to the application by launching the activity in the full application. The method 500 entails enabling the controller unit 202 to launch the activity in the full application.

The various actions, acts, blocks, steps, or the like in the method 500 may be performed in the order presented, in a different order, or simultaneously. Further, in some exemplary embodiments, some of the actions, acts, blocks, steps, or the like may be omitted, added, modified, skipped, or the like without departing from the scope of the present inventive concept.

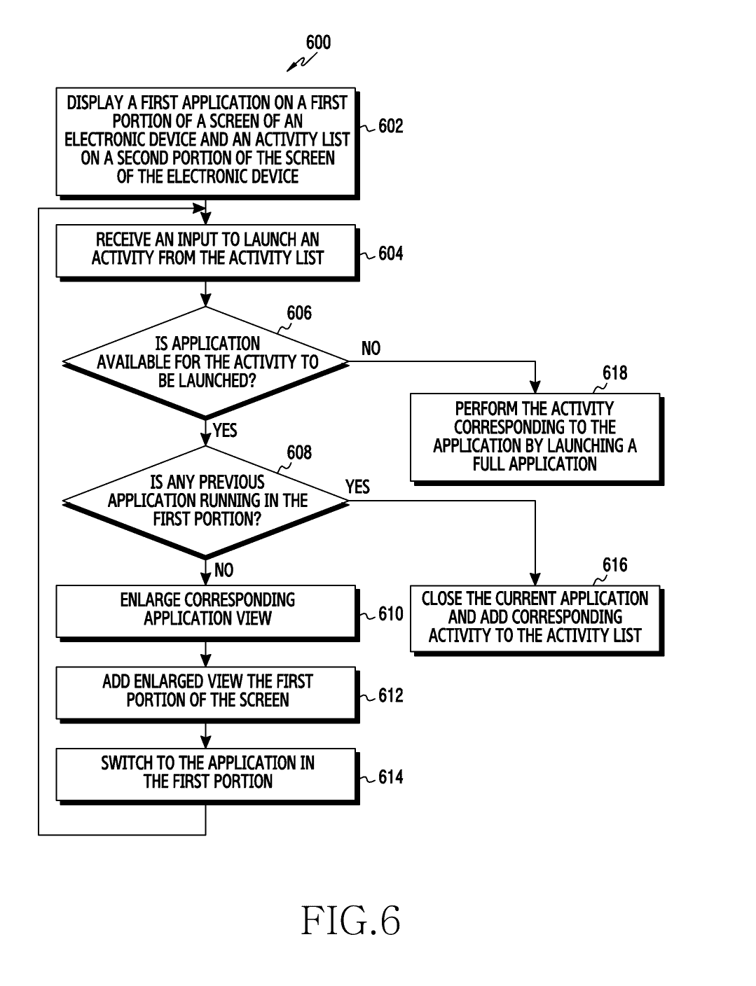

FIG. 6 is another flow diagram illustrating a method 600 for dynamically switching and managing applications in the electronic device 100, according to one or more exemplary embodiments as disclosed herein. In operation 602, the method 600 includes displaying the first application on the first portion 102a of the screen 102 and displaying the activity list on the second portion 102b of the screen 102. The method 600 entails enabling the controller unit 202 to display the first application on the first portion 102a of the screen 102 and to display the activity list on the second portion 102b of the screen 102. In an exemplary embodiment, the first application can be the miniaturized application that has basic actionable user controls of the full application.

In an exemplary embodiment, the activity list includes at least one of a recently used application, favorite applications, and notifications. In an exemplary embodiment, the notifications are displayed for the time period on the first portion 102a of the screen 102, and then dynamically switched to the second portion 102b after the time period. The notifications can be related to any of the battery low condition, the missed call, the new message, earphones connected or disconnected, downloading file status, the Wi-Fi, the Bluetooth, brightness control, or the like. In an example, the time period can be pre-defined by the user. In another example, the time period can be dynamically determined based on the type of the notification.

In operation 604, the method 600 includes receiving the input to launch the indicated activity from the activity list. The method 600 entails enabling the controller unit 202 to receive the input to launch the activity from the activity list. In an exemplary embodiment, the activity is selected from the activity list, where the input is received from the user with respect to the activity from the activity list in order to launch the activity. In another exemplary embodiment, the activity is the incoming notification. In an exemplary embodiment, the activity can be related to any of sending the message, initiating the outgoing call, capturing photos, scheduling the birthday reminder, or the like. If it is determined, in operation 606, that the application for the activity to be launched is available, then the method includes an operation 608 of determining whether any previous application is open on the first portion 102a of the screen 102. If it is determined, in operation 608, that any previous application is running on the first portion 102a of the screen 102 then, in operation 616, the method 600 includes closing the current application and adding the corresponding activity that corresponds to the application to the activity list. The method 600 entails enabling the controller unit 202 to close the current application and add the corresponding activity that corresponds to the application to the activity list.

If it is determined, in operation 608, that there is no previous application running on the first portion 102a of the screen 102 then, in operation 610, the method 600 includes inflating (i.e., enlarging) the corresponding application view. The method 600 entails enabling the controller unit 202 to enlarge the corresponding application view. In operation 612, the method 600 includes adding the inflated (i.e., enlarged) view to the first portion 102a of the screen 102. The method 600 entails enabling the controller unit 202 to add the enlarged view to the first portion 102a of the screen 102. In operation 614, the method 600 includes switching to the application on the first portion 102a of the screen 102, and then returning to operation 604. The method 600 entails enabling the controller unit 202 to switch to the application window on the first portion 102a of the screen 102.

If it is determined, in operation 606, that the application for the activity to be launched is not available, then, in operation 618, the method 600 includes performing the activity that corresponds to the application by launching the full application.

The various actions, acts, blocks, steps, or the like in the method 600 may be performed in the order presented, in a different order, or simultaneously. Further, in some exemplary embodiments, some of the actions, acts, blocks, steps, or the like may be omitted, added, modified, skipped, or the like, without departing from the scope of the present inventive concept.

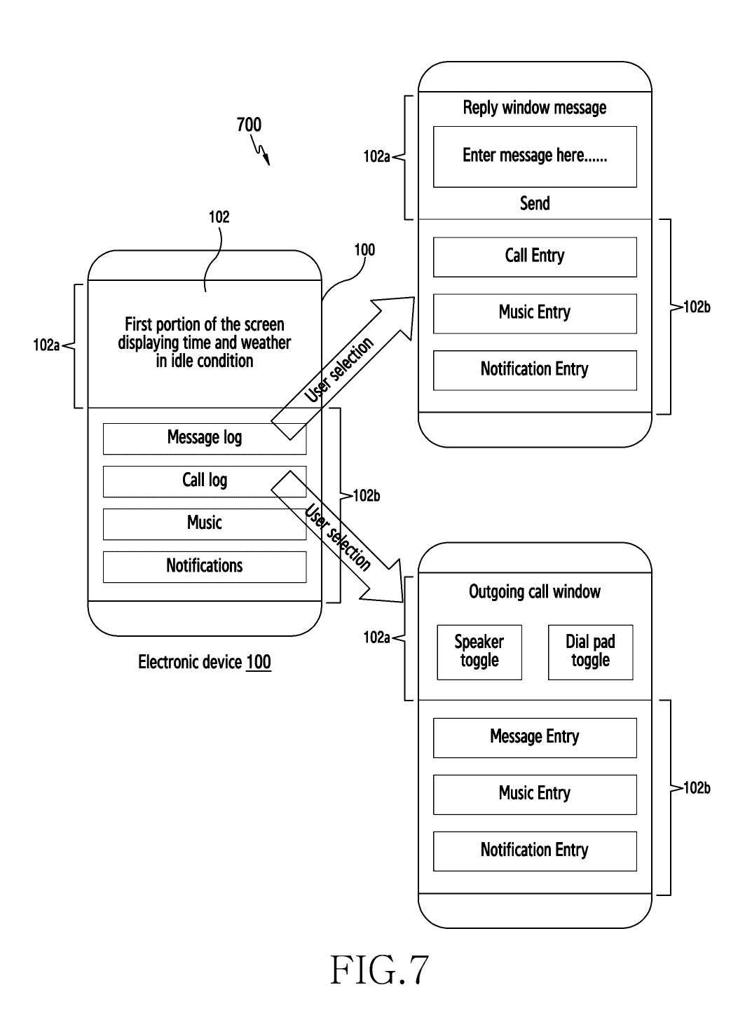

FIG. 7 shows an example system 700 for displaying the message application and the call application on the first portion 102a of the screen 102 of the electronic device 100, according to one or more exemplary embodiments. The system 700 includes the electronic device 100. As shown in the FIG. 7, the display screen 102 of the electronic device 100 is divided into the first portion 102a and the second portion 102b. The first portion 102a displays time and weather in the idle condition, and the second portion 102b displays the activity that corresponds to multiple applications, such as the message application, the call application, the music application, and received notifications as shown in FIG. 7.

Further, consider a scenario in which the user receives a message which is displayed as one of the activity imprint on the second portion 102b, as shown in FIG. 7. Further, the user selects the activity that corresponds to the message application in order to launch the activity from the activity list on the second portion 102b. Further, the activity associated with the message application is launched as the miniaturized application and displayed on the first portion 102a of the screen 102, via which the user can type a reply message and directly send the message or save as a draft for future transmission.

Further, consider a scenario in which the user receives a call which is displayed as one of the activity imprint on the second portion 102b, as shown in FIG. 7. Further, the user selects the activity imprint that corresponds to the call application in order to initiate an outgoing call from the activity list on the second portion 102b. Further, the activity associated with the call application is launched as the miniaturized application and displayed on the first portion 102a of the screen 102, via which the user can perform basic intended actions.

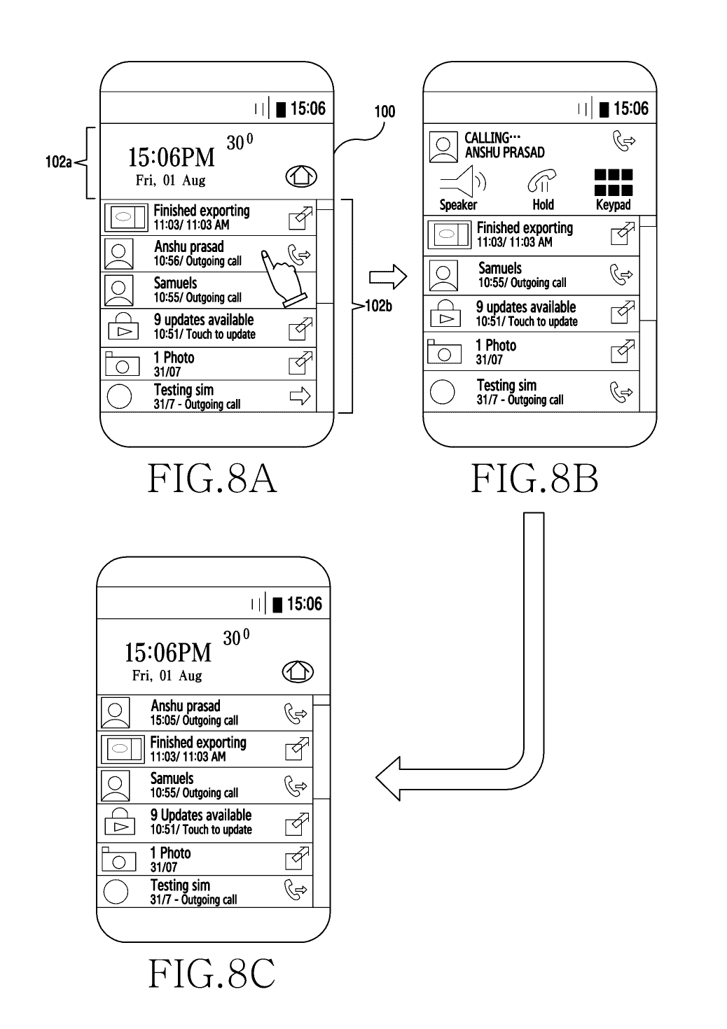

FIGS. 8A, 8B, and 8C illustrate an example for launching an outgoing call activity that corresponds to the call application on the first portion 102a of the screen 102 of the electronic device 100, according to one or more exemplary embodiments. The first portion 102a displays time and weather in the idle condition, and the second portion 102b displays the activity imprints that correspond to multiple applications, such as the message application, the call application, the play store application, and received notifications, as shown in FIG. 8A.

Further, consider a scenario in which the user has recently received a call from “Anshu Prasad” which is displayed as one of the activity imprint on the second portion 102b, as shown in FIG. 8A. If the user desires to initiate an outgoing call to “Anshu Prasad,” then the user selects “Anshu Prasad” by performing the indicated input gesture on the activity imprint. After receiving the input gesture, the outgoing call activity to “Anshu Prasad” is launched as the miniaturized application and displayed on the first portion 102a of the screen 102, via which the user can perform basic intended actions, as shown in FIG. 8B. After completing the outgoing call activity, the outgoing call activity associated with the call application is dynamically switched to the activity list which is displayed as the activity imprint on the second portion 102b of the screen 102, as shown in FIG. 8C.

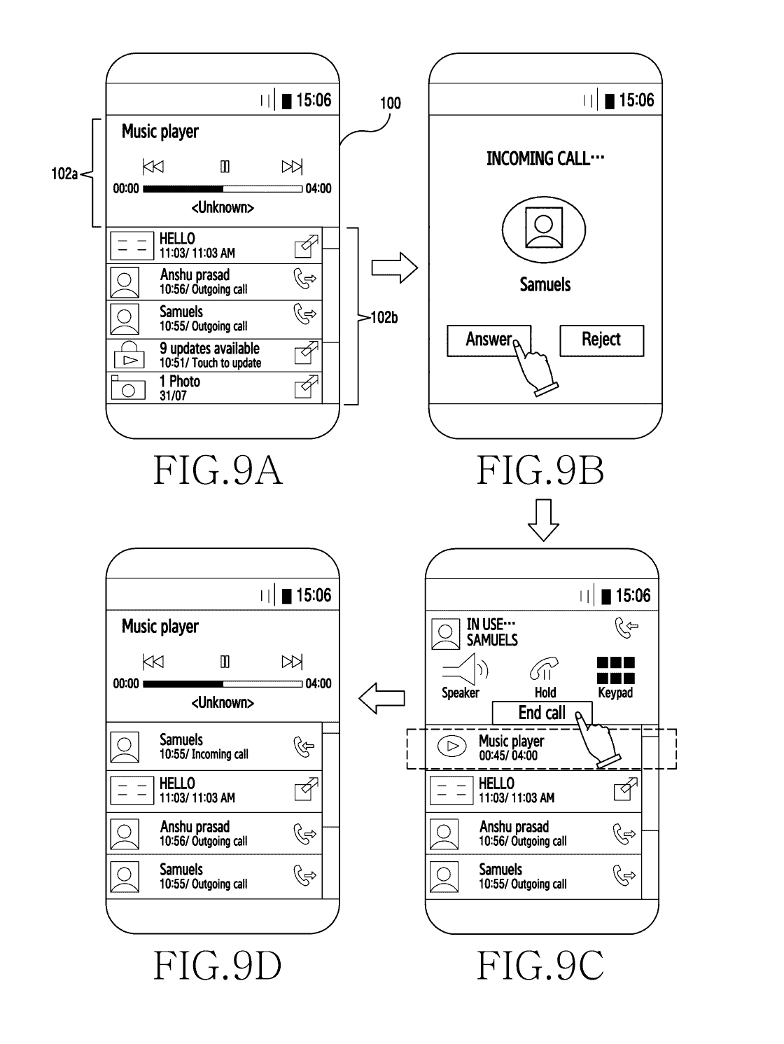

FIGS. 9A, 9B, 9C, and 9D illustrate an example for dynamically switching the music application displayed on the first portion 102a to the activity list in the second portion 102b of the screen 102 of the electronic device 100 when an incoming call activity is displayed on the first portion 102a, according to one or more exemplary embodiments. The first portion 102a displays the music application which is an ongoing activity in which the user is listening to a song. The second portion 102b displays the activity imprints that correspond to multiple applications, such as the message application, the call application, the play store application, the note pad, the camera application, and received notifications, as shown in FIG. 9A.

Further, consider a scenario in which the user receives an incoming call from “Samuels,” as shown in FIG. 9B. After the user accepts the incoming call, the incoming call activity that corresponds to the call application is displayed on the first portion 102a of the screen 102. The music application which is currently ongoing activity is dynamically switched to the activity list displayed on the second portion 102b when the call application is displayed on the first portion 102a, as shown in FIG. 9C.

Further, the music application is re-launched on the first portion 102a when the incoming call activity received from “Samuels” associated with the call application is completed. The call application is dynamically switched back to the activity list when the music application is displayed on the first portion 102a of the screen 102, as shown in FIG. 9D.

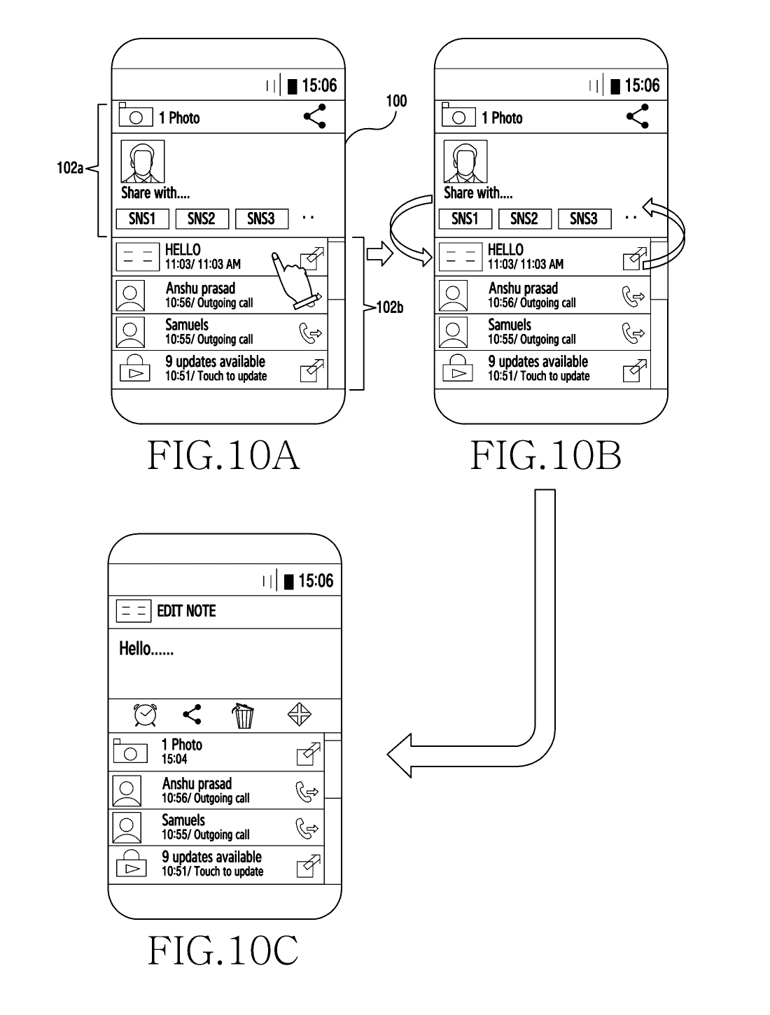

FIGS. 10A, 10B, and 10C illustrate another example for dynamically switching the camera application displayed on the first portion 102a to the activity list in the second portion 102b when the note pad application is displayed on the first portion 102a, according to one or more exemplary embodiments. The first portion 102a displays the camera application which is ongoing activity in which the user has captured a photo. The second portion 102b displays the activity imprints that correspond to multiple applications, such as the note pad, the call application, and received notifications, as shown in FIG. 10A.

Further, consider a scenario in which the user wants to access the note pad application in the activity list. The user selects the activity imprint that corresponds to the note pad application in order to launch the activity from the activity list on the second portion 102b, as shown in FIG. 10A. The camera application and the note pad application are dynamically switched, as represented by arrows in FIG. 10B.

Further, the activity (i.e., edit notes) associated with the note pad application is launched as the miniaturized application and displayed on the first portion 102a of the screen 102, via which the user can access the note pad. The camera application which is currently ongoing is dynamically switched to the activity list displayed on the second portion 102b when the note pad application is displayed on the first portion 102a, as shown in FIG. 10C.

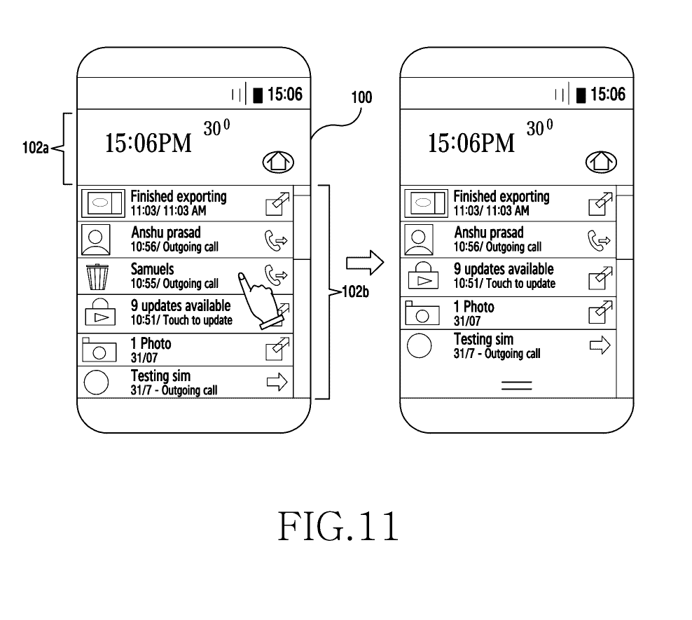

FIG. 11 illustrates an example for deleting an application from the activity list displayed on the second portion 102b of the screen 102 of the electronic device 100, according to one or more exemplary embodiments. The user selects the outgoing call activity of “Samuels” in order to delete the activity from the activity list by performing the indicated input gesture, as shown in FIG. 11.

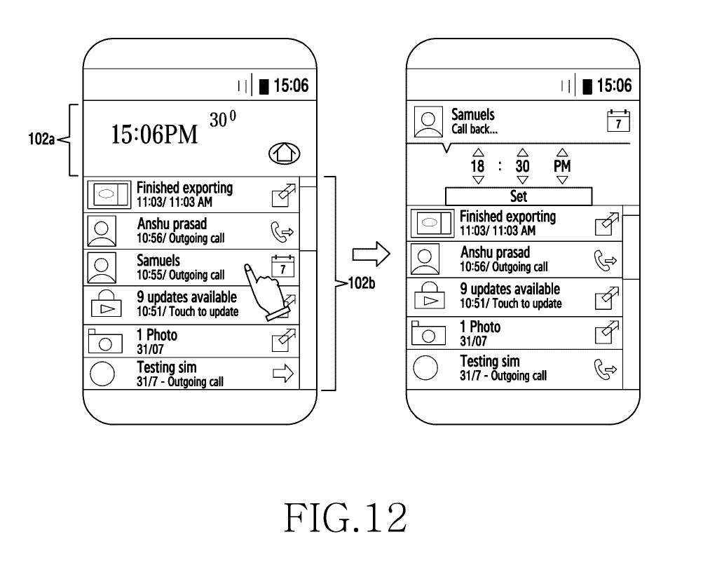

FIG. 12 illustrates an example for scheduling the outgoing call activity that corresponds to the call application from the activity list displayed on the second portion 102b of the screen 102 of the electronic device 100, according to one or more exemplary embodiments. The user selects the outgoing call activity of “Samuels” in order to schedule the outgoing call activity for later retrieval from the activity list by performing the indicated input gesture, as shown in FIG. 12.

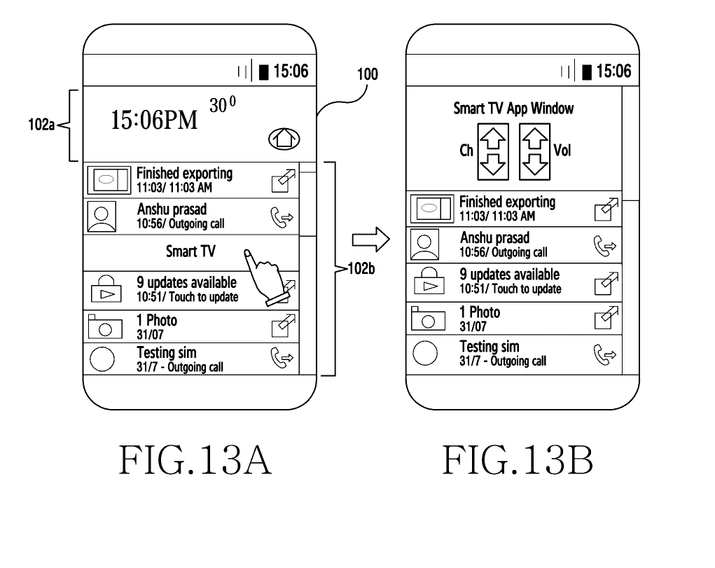

FIG. 13A and FIG. 13B illustrate an example for controlling a smart Television (TV) by launching a smart TV application on the first portion 102a of the screen 102, according to one or more exemplary embodiments. The user selects the smart TV application by performing the indicated input gesture on the smart TV application, as shown in FIG. 13A. The user selects the smart TV application in order to invoke a desired action with respect to the smart TV, such as changing the channel and/or increasing or decreasing the volume of the smart TV, by launching the miniaturized application of the smart TV on the first portion 102a of the screen 102, as shown in FIG. 13B.

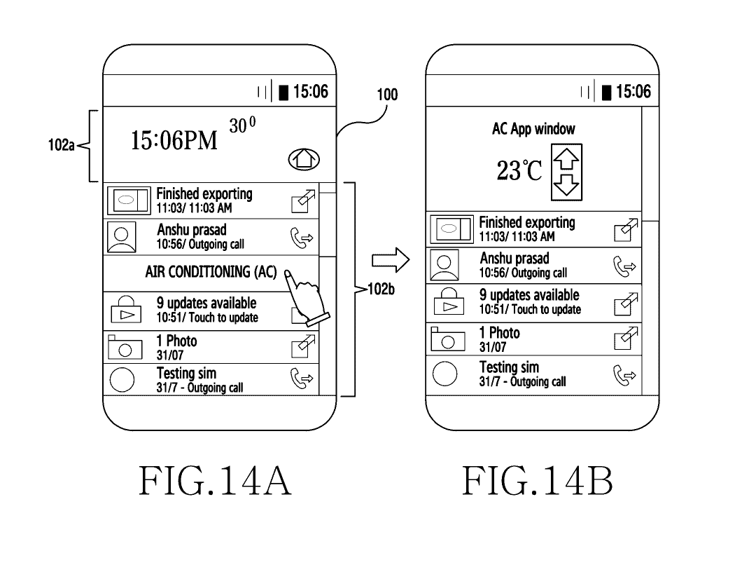

FIG. 14A and FIG. 14B illustrate an example for controlling an air conditioner (AC) by launching an AC application on the first portion 102a of the screen 102, according to one or more exemplary embodiments. The user selects the AC application by performing the indicated input gesture with respect to the AC application, as shown in FIG. 14A. The user selects the AC application in order to invoke a desired action with respect to the AC, such as to set the room temperature for the AC, by launching the miniaturized application window of the AC on the first portion 102a of the screen 102, as shown in FIG. 14B.

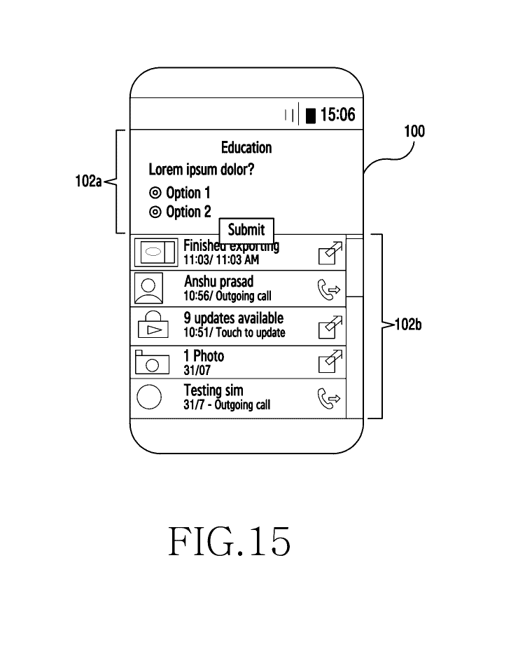

FIG. 15 shows another example illustration for managing a smart classroom application in the electronic device 100, according to one or more exemplary embodiments. The activity list on the second portion 102b can include the smart classroom application in order to invoke a desired action with respect to the smart classroom application. The user can respond to questions by launching the smart classroom application on the first portion 102a of the screen 102, as shown in FIG. 15.

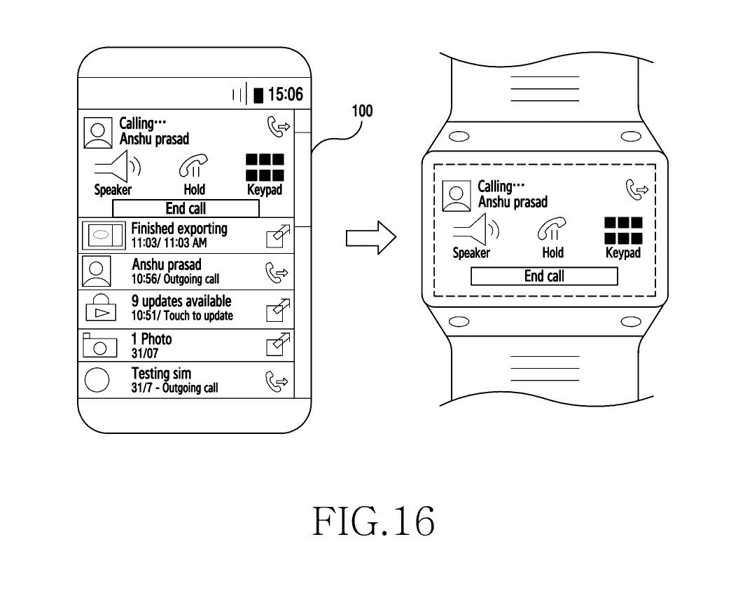

FIG. 16 illustrates an example for dynamically synchronizing the first portion 102a of the screen 102 of the electronic device 100 with a watch (i.e., a wearable external device), according to one or more exemplary embodiments. The first portion 102a displays the ongoing outgoing call activity with “Anshu Prasad,” as shown in FIG. 16. The first portion 102a of the screen 102 is dynamically synchronized with the watch, such that the watch displays the same ongoing outgoing call activity with “Anshu Prasad,” as shown in FIG. 16.

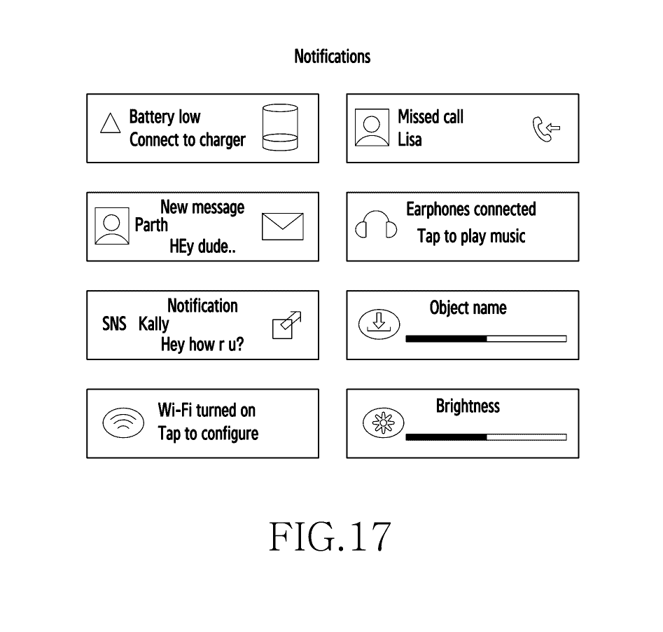

FIG. 17 illustrates examples of notifications displayed on the first portion 102a of the screen 102 of the electronic device 100, according to one or more exemplary embodiments. The notifications can be related to any of a battery low condition, missed call, message, earphones connected or disconnected, downloading file status, Wi-Fi, and brightness control, as shown in FIG. 17. The notifications are displayed for the time period on the first portion 102a of the screen 102, and are then dynamically switched to the second portion 102b after the time period.

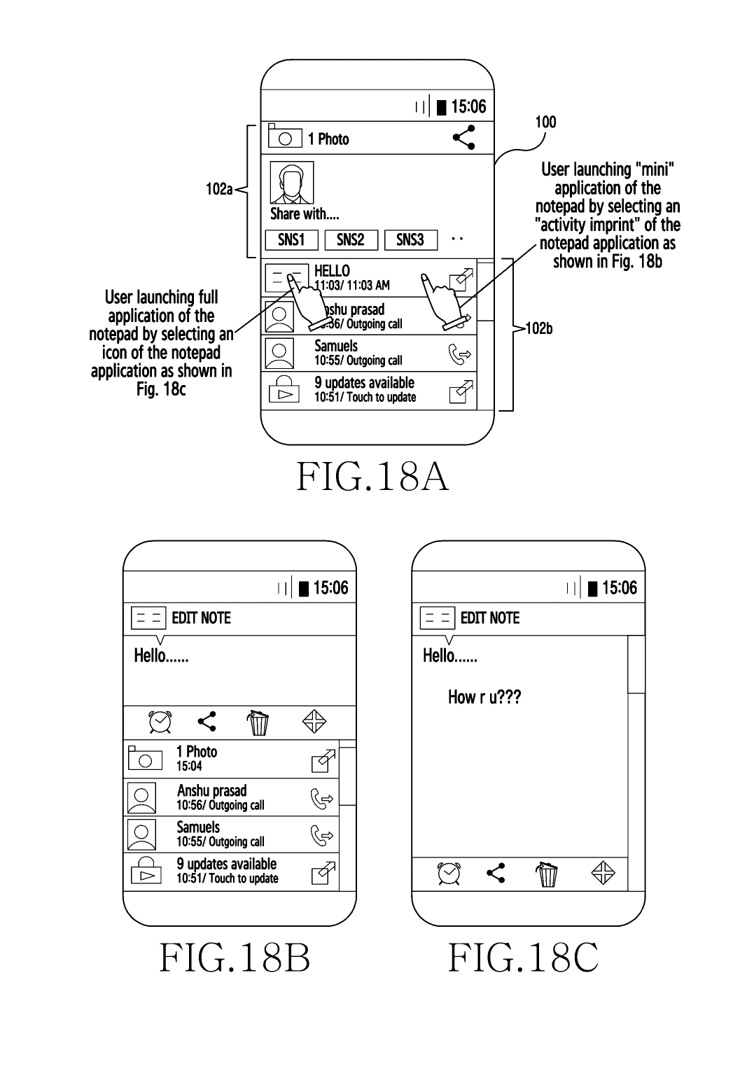

FIGS. 18A, 18B, and 18C illustrate an example for launching the miniaturized version of the notepad application on the first portion 102a and the full notepad application on the screen 102 of the electronic device 100, according to one or more exemplary embodiments. The first portion 102a displays the camera application which is ongoing activity in which the user has captured a photo. The second portion 102b displays the activity imprints that correspond to multiple applications, such as the note pad, the call application, and received notifications, as shown in FIG. 18A.

Further, consider a scenario in which the user wants to access the note pad application in the activity list. The user selects the activity imprint that corresponds to the note pad application in order to launch the activity from the activity list on the second portion 102b, as shown in FIG. 18A. The camera application and the note pad application are dynamically switched, and the activity (i.e., edit notes) associated with the note pad application is launched as the miniaturized application and displayed on the first portion 102a of the screen 102, via which the user can access the note pad. The camera application which is currently ongoing is dynamically switched to the activity list displayed on the second portion 102b when the note pad application is displayed on the first portion 102a, as shown in FIG. 18B.

Further, if the user selects the icon that corresponds to the note pad application in order to launch the activity (i.e., edit notes) from the activity list on the second portion 102b (as shown in FIG. 18A), then the activity associated with the note pad application is launched as the full application and displayed on the screen 102 of the electronic device 100, via which the user can access the note pad as shown in FIG. 18C.

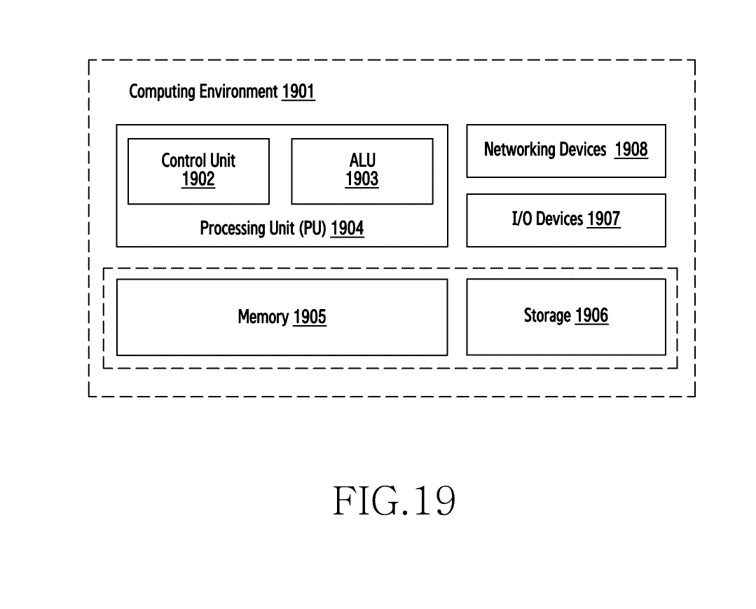

FIG. 19 illustrates a computing environment which is suitable for implementing the method for dynamically switching and managing applications of the electronic device 100, according to one or more exemplary embodiments. As depicted in FIG. 19, the computing environment 1901 comprises at least one processing unit 1904 that is equipped with a control unit 1902 and an Arithmetic Logic Unit (ALU) 1903, a memory 1905, a storage unit 1906, a plurality of networking devices 1908, and a plurality of input/output (I/O) devices 1907. The processing unit 1904 is configured for processing the instructions of the algorithm. The processing unit 1904 receives commands from the control unit in order to perform the processing. Further, any logical and arithmetic operations involved in the execution of the instructions are computed by the ALU 1903.

The overall computing environment 1901 can be composed of any of multiple homogeneous and/or heterogeneous cores, multiple CPUs of different kinds, special media and other accelerators. The processing unit 1904 is configured for processing the instructions of the algorithm. Further, the plurality of processing units 1904 may be located on a single chip or over multiple chips.

The algorithm that includes instructions and codes required for the implementation are stored in either the memory unit 1905 or the storage 1906 or both. At the time of execution, the instructions may be retrieved from the corresponding memory 1905 or storage 1906, and executed by the processing unit 1904.

In case of any hardware implementations, any of various networking devices 1908 or external I/O devices 1907 may be connected to the computing environment to support the implementation via the networking unit 1908 and/or the I/O device unit 1907.

The exemplary embodiments disclosed herein can be implemented by using at least one software program running on at least one hardware device and performing network management functions to control the elements. The elements shown in FIGS. 1 through 19 include blocks which can be implemented as at least one of a hardware device, or as a combination of hardware device and software module.

The foregoing description of the exemplary embodiments will so fully reveal the general nature of the present inventive concept that others can, by applying current knowledge, readily modify and/or adapt for various applications such exemplary embodiments without departing from the generic concept, and, therefore, such adaptations and modifications should and are intended to be comprehended within the meaning and range of equivalents of the disclosed exemplary embodiments. It is to be understood that the phraseology or terminology employed herein is for the purpose of description and not of limitation. Therefore, while the exemplary embodiments have been described in terms of preferred embodiments, those skilled in the art will recognize that the exemplary embodiments can be practiced with modification within the spirit and scope of the exemplary embodiments as described herein.

What is claimed is:

1. A method for operating an electronic device, the method comprising:
displaying a user interface (UI) comprising a first region and a second region, the second region within which a plurality of objects are displayed; and
displaying, in the first region, at least one selected object that corresponds to a first input, from among the plurality of objects,
wherein each of the plurality of objects corresponds to one from among an application stored in the device and a notification generated in the device, and
wherein the at least one selected object is usable for activating at least one function from among a plurality of functions associated with the application or the notification that corresponds to the at least one selected object.

2. The method of claim 1, further comprising:
deleting the at least one selected object from the second region.

3. The method of claim 2, further comprising:
displaying, when an operation associated with the at least one selected object is complete, the deleted at least one object in the second region.

4. The method of claim 1, further comprising:
displaying, in response to receiving a second input that relates to the at least one selected object, information associated with the at least one function in the first region.

5. The method of claim 1, further comprising:
displaying, when the first input is not generated in the device, default information that relates to the device in the first region.

6. The method of claim 1, wherein when a respective application is executed or a respective notification is generated, a corresponding one of the plurality of objects is generated, and
wherein the plurality of objects is displayed by aligning the objects based on one from among an execution order of the corresponding applications and an order of generation of the objects.

7. The method of claim 1, wherein the first input comprises at least one from among a generation of a notification and a user's touch input that relates to one of the plurality of objects.

8. The method of claim 1, further comprising:
synchronizing with at least a second electronic device; and
transmitting information that relates to displaying the UI in the at least second electronic device.

9. The method of claim 1, further comprising:
displaying an additional object that corresponds to a second input, from among the plurality of objects,
wherein the additional object is usable for displaying an additional UI that corresponds to the additional object, and
wherein the additional UI is overlapped with the displayed UI.

10. A non-transitory computer-readable medium having recorded thereon a program executable by a computer for performing a method comprising:
displaying a user interface (UI) comprising a first region and a second region, the second region within which a plurality of objects are displayed; and
displaying, in the first region, at least one selected object that corresponds to a designated input, from among the plurality of objects,
wherein each of the plurality of objects corresponds to one from among an application stored in the device and a notification generated in the device, and
wherein the at least one selected object is usable for activating at least one function from among a plurality of functions associated with the application or the notification that corresponds to the at least one selected object.

11. An electronic device comprising:
at least one processor; and
a display operatively coupled to the at least one processor,
wherein the at least one processor is configured to:
display a user interface (UI) comprising a first region and a second region, the second region within which a plurality of objects are displayed; and
display, in the first region, at least one selected object that corresponds to a first input, from among the plurality of objects,
wherein each of the plurality of objects corresponds to one from among an application stored in the device and a notification generated in the device, and
wherein the at least one selected object is usable for activating at least one function from among a plurality of functions associated with the application or the notification that corresponds to the at least one selected object.

12. The device of claim 11, wherein the at least one processor is further configured to delete the at least one selected object from the second region.

13. The device of claim 12, wherein the at least one processor is further configured to display, when an operation associated with the at least one selected object is complete, the deleted at least one object in the second region.

14. The device of claim 11, wherein the at least one processor is further configured to display, in response to receiving a second input that relates to the at least one selected object, information associated with the at least one function in the first region.

15. The device of claim 11, wherein the at least one processor is further configured to display, when the first input is not generated in the device, default information that relates to the device in the first region.

16. The device of claim 11, wherein when a respective application is executed or a respective notification is generated, a corresponding one of the plurality of objects is generated, and
wherein the plurality of objects is displayed by aligning the objects based on one from among an execution order of the corresponding applications and an order of generation of the objects.

17. The device of claim 11, wherein the first input comprises at least one from among a generation of a notification and a user's touch input that relates to one of the plurality of objects.

18. The device of claim 11, wherein the at least one processor is further configured to:
synchronize with at least a second electronic device; and
transmit information that relates to displaying the UI in the at least second electronic device.

19. The device of claim 11, wherein the at least one processor is further configured to display an additional object that corresponds to a second input, from among the plurality of objects,
wherein the additional object is usable for displaying an additional UI that corresponds to the additional object, and
wherein the additional UI is overlapped with the displayed UI.

20. The device of claim 11, wherein each of the plurality of objects corresponds to one from among a notification generated in the device during a preset period and an application executed in the device during the preset period.
